(19) United States
(12) Patent Application Publication
(10) Pub. No.: US 2007/0126861 A1
(43) Pub. Date: Jun. 7, 2007

(54) Apparatus and method for connecting video call in mobile terminal

(75) Inventors: Yu-Shin Kim, Osan-si (KR); Joo-Hyun Lee, Paju-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/633,934

(22) Filed: Dec. 5, 2006

(30) Foreign Application Priority Data
Dec. 5, 2005 (KR) 2005-0117442

(51) Int. Cl. H04N 7/14

(52) U.S. Cl. 348/14.02

(57) ABSTRACT

Provided is an apparatus and method for performing a video call connection in a mobile terminal with a video call function. The method includes receiving a video call connection request message from the mobile terminal and detecting the phone number of a called party for a video call from the received video call connection request message, determining whether the called party is a video call service subscriber, and, if the called party is not a video call service subscriber, transmitting to the mobile terminal a message indicating that the called party is not a video call service subscriber. The cause of the video call connection failure is subdivided and information of the precise failure cause is provided to the mobile terminal. Accordingly, a user of the mobile terminal can know the precise cause of the video call connection failure.

### PRIORITY

This application claims priority under 35 U.S.C. § 119 to an application filed in the Korean Intellectual Property Office on Dec. 5, 2005 and assigned Serial No. 2005-117442, the contents of which are incorporated herein by reference.

### BACKGROUND OF THE INVENTION

1. Field of the Invention

The present invention relates generally to an apparatus and method for connecting a video call in a mobile terminal, and, in particular, to an apparatus and method for providing information about the detailed causes of a video call connection failure in a mobile terminal, subdivided according to a provision status of a video call service and whether a called party is a video call service subscriber.

2. Description of the Related Art

An International Mobile Telecommunications-2000 (IMT-2000) system, applied as a third-generation (3G) mobile communication system, is used to establish a worldwide wireless call network, thereby enabling many unspecified persons to perform wireless calls internationally using a portable phone. A Wideband Code Division Multiple Access (WCDMA) system is based on the IMT-2000 system and a Universal Mobile Telecommunications System (UMTS). The WCDMA system uses a wide frequency band of 5 MHz, thereby making it possible to receive a multipath fading channel and to provide more multipath components. Accordingly, the WCDMA system can enhance reception (RX) quality due to rake-time diversity and is thus suitable for high-rate data transmission. Therefore, the WCDMA system can provide users with not only a wireless voice call service but also a file/image service such as an Internet service and a video call service.

When a video call connection fails, a conventional video call service system notifies a caller of the connection failure. For example, notification may be provided when a called party is not a subscriber of a video call service and thus is unable to receive the video call service. Another example is where a called party is a video call service subscriber but is temporarily out of a video call service area and thus is temporarily unable to receive video call service. In these two cases, the video call connection fails and the conventional video call service system notifies a caller that the video call service is impossible.

As described above, the conventional video call service system notifies the caller of the video call connection failure without discriminating between the above two cases. For this reason, the caller cannot know the precise cause of the video call connection failure.

### SUMMARY OF THE INVENTION

An object of the present invention is to substantially solve at least the above problems and/or disadvantages and to provide at least the advantages below. Accordingly, an object of the present invention is to provide an apparatus and method for notifying the precise cause of a video call connection failure in a mobile terminal.

Another object of the present invention is to provide an apparatus and method for notifying the precise cause of a video call connection failure in a mobile terminal by subdividing the failure cause according to the provision status of a video call service and whether a called party is a video call service subscriber.

According to one aspect of the present invention, there is provided a method for notifying the cause of a video call connection failure in a mobile terminal with a video call function, the method including receiving a video call connection request message from the mobile terminal and detecting the phone number of a called party for a video call from the received video call connection request message; determining whether the called party is a video call service subscriber; and, if the called party is not a video call service subscriber, transmitting to the mobile terminal a message indicating that the called party is not a video call service subscriber.

According to another aspect of the present invention, there is provided a method for performing a video call connection in a mobile terminal with a video call function, the method including transmitting a video call connection request message for a called party's terminal from the mobile terminal to a video call management server; determining whether a response message is received from the video call management server; if the response message is received, determining whether the received response message is a video call connection failure message; if the received response message is a video call connection failure message, detecting the cause of the video call connection failure from the received response message; and displaying the detected failure cause.

According to a further aspect of the present invention, there is provided an apparatus for performing a video call connection in a mobile terminal with a video call function, the apparatus including a storage unit for storing video call service conditions; a controller for transmitting a video call connection request message to a video call management server when a video call connection with a called party is requested, receiving a video call connection failure message from the video call management server, and detecting the connection failure cause contained in the received call connection failure message by reading the video call service conditions from the storage unit; and a display unit for displaying the detected connection failure cause under the control of the controller.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates a system for notifying the precise cause of a video call connection failure in a mobile terminal according to the present invention;

FIG. 2 is a block diagram of a mobile terminal according to the present invention;

FIG. 3 is a flowchart illustrating a procedure for providing notification of the precise cause of a video call connection failure in a mobile terminal according to the present invention; and

FIG. 4 is a flowchart illustrating a procedure for providing notification, at a video call management server, of the precise cause of a video call connection failure in the mobile terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

The present invention provides a scheme for notifying the precise cause of a video call connection failure in a mobile terminal by subdividing the failure cause according to the provision status of a video call service and whether a called party is a video call service subscriber.

In the following description, a video call management server refers to a server that retains information for video call connection (e.g., the IDs or locations of video call service subscribers) to provide a video call connection between mobile terminals.

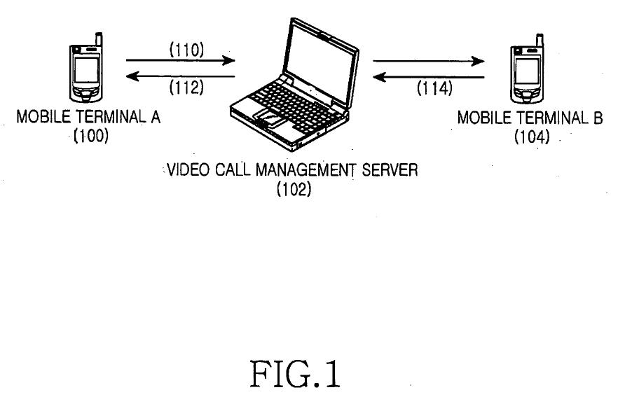

FIG. 1 illustrates a system for notifying the precise cause of a video call connection failure in a mobile terminal according to the present invention. Referring to FIG. 1, a mobile terminal A 100 transmits a video call connection request message 110 to a video call management server 102 so as to perform a video call with a mobile terminal B 104. Upon receipt of the video call connection request message, the video call management server 102 detects the current conditions of the mobile terminal B 104 to determine whether the video call connection is possible. If mobile terminal B 104 does not subscribe to the video call service, the video call management server 102 transmits a video call connection failure message 112 to the mobile terminal A 100.

Likewise, if the mobile terminal B 104 does not subscribe to the video call service but is temporarily out of a video call service area and thus temporarily unable to receive the video call service, the video call management server 102 transmits the video call connection failure message 112 to the mobile terminal A 100. At this point, the location of the mobile terminal B 104 can be obtained using a Home Location Register (HLR) and a Visitor Location Register (VLR). The HLR refers to a database that stores the locations of home base stations. The VLR refers to a database that manages the locations of mobile terminals that has deviated from their home locations.

Upon receipt of the video call connection failure message, the mobile terminal A 100 detects the failure cause from the received video call connection failure message and displays the detected failure cause on its display unit.

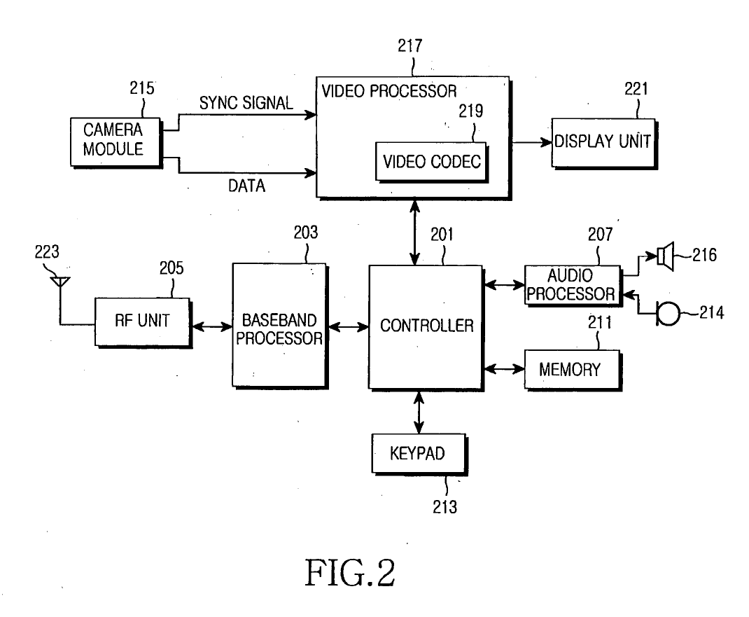

FIG. 2 is a block diagram of a mobile terminal with a video call function according to the present invention. Referring to FIG. 2, the mobile terminal includes a controller (e.g., a microprocessor unit (MPU)) 201, a baseband processor 203, a radio-frequency (RF) unit 205, an audio processor 207, a memory 211, a keypad 213, a microphone 214, a camera module 215, a speaker 216, a video processor 217, a display unit 221, and an antenna 223. The video processor 217 includes a video coder-decoder (CODEC) 219, and the audio processor 207 may be an audio CODEC.

The controller 201 controls an overall operation of the mobile terminal. For example, the controller 201 processes and controls voice communication and data communication. In addition to the general functions, the controller 201 controls a video call connection according to the present invention. Also, when a video call connection fails, the controller 201 receives a video call connection failure message containing the cause of the video call connection failure and displays the failure cause on the display unit 221. A detailed description about the general control operation of the controller 201 will be omitted for conciseness.

The memory 211 may include a program memory, a data memory, and a motion picture memory. The program memory stores a variety of reference data and microcodes of a program for the process/control operations of the controller 201. According to the present invention, the program memory stores a program for requesting a video call connection and a program for receiving the video call connection failure message containing the cause of the video call connection failure to display the failure cause on the display unit 221. The data memory includes a Random Access Memory (RAM) and a flash Read-Only Memory (ROM). The RAM is a working memory of the controller 201, which stores temporary data that are generated during the execution of various programs. The flash ROM stores a variety of updatable data such as phone book data, outgoing messages, and incoming messages. According to the present invention, the flash ROM stores a table for indicating whether a video call service is possible. Table 1 below illustrates preferred contents of the table.

TABLE 1

| Cause Num | Cause |
|---|---|
| 1 | Unassigned (unallocated) number |
| 3 | No route to destination |
| 6 | Channel unacceptable |
| 8 | Operator determined barring |
| 10 | MT_VT_not_available |
| 11 | MT_VT_available_but_out_of_service |
| 16 | Normal call clearing |
| 17 | User busy |
| 18 | No user responding |
| 19 | User alerting, no answer |
| 21 | Call rejected |

In Table 1, “Cause Num” refers to codes for discriminating between the causes of a video call connection failure. “Cause” refers to the causes of the video call connection failure. For example, “Cause Num: 17,Cause: User busy” indicates that the phone line of a called party is busy. “Cause Num: 21,Cause: Call rejected” indicates that a called party rejects a video call.

In particular, “Cause Num: 10, MT_VT_not_available” indicates that a video call connection fails because a called party is not a video call service subscriber. “Cause Num: 11, MT_VT_available_but_out_of_service” indicates that a video call connection fails because a called party is a video call service subscriber but is temporarily unable to receive the video call service.

The data in Table 1 are identical to data that are stored in the video call management server 102 to indicate whether a video call service is possible.

The data memory may include a text buffer for buffering text signals inputted using the keypad 213, an image buffer for buffering motion picture signals generated by the video CODEC 219, and an audio buffer for buffering audio signals. The motion picture memory stores motion picture signals.

The keypad 213 includes numeric keys of digits 0-9 and a plurality of function keys, such as a Menu key, a Cancel (Delete) key, a Confirmation key, a Talk key, an End key, a shutter key, an Internet connection key, and Navigation keys

[symbol]

The keypad 213 provides the controller 201 with key input data that corresponds to a key pressed by a user.

The display unit 221 displays status information generated during an operation of the mobile terminal, numerals and characters, moving pictures and still pictures, and so on. The display unit 221 may be a color Liquid Crystal Display (LCD). According to the present invention, the display unit 221 displays a video call image provided from an opponent terminal under the control of the controller 201. In addition, the display unit 221 displays a message indicating the cause of the video call connection failure.

The audio processor 207 connected to the controller 201, and the microphone 214 and the speaker 216 connected to the audio processor 207 constitute an audio input/output block that is used for telephone communication and voice recording. The audio processor 207 converts Pulse Code Modulation (PCM) data received from the controller 201 into analog audio signals and outputs the analog audio signals to the speaker 216. Also, the audio processor 207 converts audio signals received from the microphone 214 into PCM data and provides the PCM data to the controller 201.

The RF unit 205 down-converts an RF signal received through the antenna 223 and provides the resulting baseband signal to the baseband processor 203. Also, the RF unit 205 up-converts a baseband signal provided from the baseband processor 203 and transmits the resulting RF signal through the antenna 223. The baseband processor 203 processes baseband signals that are exchanged between the RF unit 205 and the controller 201. For example, the baseband processor 203 performs channel coding and spreading on data to be transmitted, and performs despreading and channel decoding on received data.

The camera module 215 includes a camera sensor and a signal processor. The camera sensor converts optical signals detected in a photographing mode into electrical signals. The signal processor converts analog image signals received from the camera sensor into digital data. The camera sensor may be a Charge Coupled Device (CCD) sensor, and the signal processor may be a Digital Signal Processor (DSP). In a video call mode, the camera module 215 takes and provides an image of a user to the video processor 217 under the control of the controller 201.

The video processor 217 converts video signals received from the camera module 215 into video data. That is, the video processor 217 processes the video signals on a frame basis and adjusts the resulting frame video data to the size and characteristics of the display unit 221. The video CODEC 219 of the video processor 217 encodes a video signal in a predetermined coding scheme and decodes the encoded frame video data into original frame video data. The video processor 217 generates and reproduces motion picture signals in accordance with a set mode under the control of the controller 201.

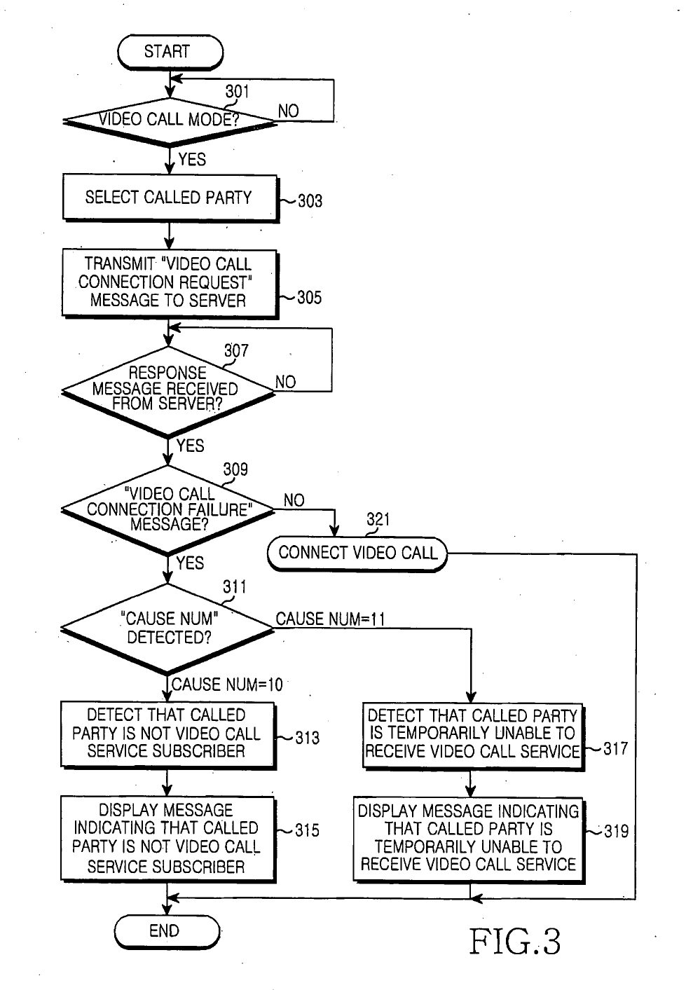

FIG. 3 is a flowchart illustrating a procedure for providing notification of the precise cause of a video call connection failure in the mobile terminal according to the present invention. Referring to FIG. 3, the controller 201 determines in step 301 if the mobile terminal is in a video call mode. If so, the procedure proceeds to step 303; and, if not, the procedure repeats step 301. In step 303, a user of the mobile terminal selects a called party for a video call.

In step 305, the controller 201 transmits a video call connection request message for the called party to the video call management server. In step 307, the controller 201 determines if a response message is received from the video call management server. If so, the procedure proceeds to step 309; and, if not, the procedure repeats step 307.

In step 309, the controller 201 determines if the received response message is a video call connection failure message. If so, the procedure proceeds to step 311; and, if not, the procedure proceeds to step 321. In step 321, the controller 201 performs a video call connection with a mobile terminal of the called party.

In step 311, the controller 201 detects the “Cause Num” of the video call connection failure message. For example, if the “Cause Num” is “10”, the controller 201 detects that the called party is not a video call service subscriber, in step 313. In step 315, the controller 201 displays a message indicating that the called party is not a video call service subscriber on the display unit 221.

On the other hand, if the “Cause Num” is “11”, the controller 201 detects that the called party is temporarily unable to receive the video call service, in step 317. In step 319, the controller 201 displays a message indicating that the called party is temporarily unable to receive the video call service on the display unit 221. Thereafter, the controller 201 ends the procedure.

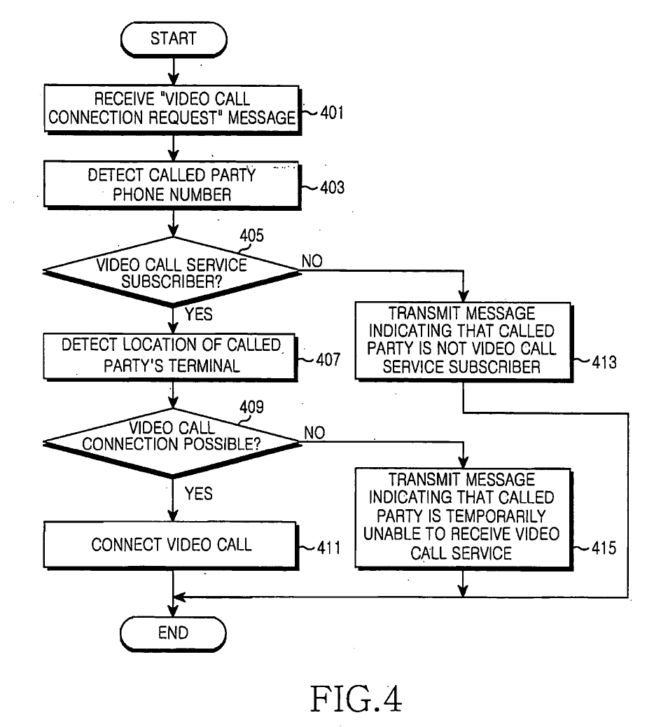

FIG. 4 is a flowchart illustrating a procedure for providing notification, at the video call management server, of the precise cause of a video call connection failure in the mobile terminal according to the present invention. Referring to FIG. 4, a controller of the video call management server receives a video call connection request message from the mobile terminal in step 401. In step 403, the server controller detects the phone number of a called party from the video call connection request message.

In step 405, the server controller determines if the called party is a video call service subscriber. If the called party is not a video call service subscriber, the server controller transmits a message containing a code indicating that the called party is not a video call service subscriber to the mobile terminal, in step 413. For example, if the called party is not a video call service subscriber, the server controller transmits to the mobile terminal a message whose “Cause Num” is “10”. Thereafter, the server controller ends the procedure.

On the other hand, if in step 405 it is determined that the called party is a video call service subscriber, the server controller detects the location of the called party's terminal in step 407.

In step 409, the server controller determines if the called party is located in a video call service area and thus able to receive the video call service. If so, the procedure proceeds to step 411; and, if not, the procedure proceeds to step 415.

In step 415, the server controller transmits a message containing a code indicating that the called party is temporarily unable to receive the video call service to the mobile terminal. For example, if the called party is a video call service subscriber but is out of a video call service area, the video server transmits to the mobile terminal a message whose “Cause Num” is “11”.

In step 411, the server controller attempts to perform a video call connection between the mobile terminal and the called party's terminal by transmitting a message indicating the occurrence of the video call connection request message to the called party's terminal. Thereafter, the server controller ends the procedure. It will be recognized that the procedures described with reference to FIGS. 3 and 4 can be similarly applied to the other failure causes illustrated in Table 1.

As described above, the present invention subdivides the cause of a video call connection failure and provides information about the subdivided failure cause to the user of the mobile terminal, thereby making it possible for the user to know the precise cause of the video call connection failure.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method of video call management server for providing notification of the cause of a video call connection failure to a mobile terminal with a video call function, the method comprising the steps of:
receiving a video call connection request message from the mobile terminal and detecting a phone number of a called party for a video call from the received video call connection request message;
determining whether the called party is a video call service subscriber; and
if the called party is not a video call service subscriber, transmitting to the mobile terminal a message indicating that the called party is not a video call service subscriber.

2. The method of claim 1, further comprising:
if the called party is a video call service subscriber, determining whether the called party is able to receive video call service; and
if the called party is unable to receive video call service, transmitting to the mobile terminal a message indicating that the called party is temporarily unable to receive video call service.

3. The method of claim 2, wherein whether the called party is able to receive video call service is determined based on a location of the called party.

4. The method of claim 3, wherein the location of the called party is obtained using a Home Location Register (HLR) or a Visitor Location Register (VLR).

5. A method for performing a video call connection in a mobile terminal with a video call function, the method comprising the steps of:
transmitting a video call connection request message for a called party's terminal to a video call management server;
determining whether a response message is received from the video call management server;
if the response message is received, determining whether the received response message is a video call connection failure message;
if the received response message is a video call connection failure message, detecting the cause of the video call connection failure from the received response message; and
displaying the detected failure cause.

6. The method of claim 5, further comprising, if the received response message is not a video call connection failure message, performing a video call connection with the called party.

7. The method of claim 5, further comprising, if the video call connection fails because the called party is not a video call service subscriber, displaying a message indicating that the called party is not a video call service subscriber.

8. The method of claim 5, further comprising, if the video call connection fails because the called party is temporarily unable to receive video call service due to communication obstacles, displaying a message indicating that the called party is temporarily unable to receive video call service.

9. An apparatus for performing a video call connection in a mobile terminal with a video call function, the apparatus comprising:
a storage unit for storing video call service conditions;
a controller for transmitting a video call connection request message to a video call management server when a video call connection with a called party is requested, receiving a video call connection failure message from the video call management server, and detecting a connection failure cause contained in the received video call connection failure message by reading video call service conditions from the storage unit; and
a display unit for displaying the detected connection failure cause.

10. The apparatus of claim 9, wherein if the video call connection fails because the called party is not a video call service subscriber, the controller displays on the display unit a message indicating that the called party is not a video call service subscriber.

11. The apparatus of claim 9, wherein if the video call connection fails because the called party is temporarily unable to receive video call service due to communication obstacles, the controller displays on the display unit a message indicating that the called party's terminal is temporarily unable to receive video call service.

12. A method of providing notification of the cause of a video call connection failure in a video call management server to a mobile terminal having a video call function, the method comprising the steps of:
detecting a phone number of a called party for a video call from a received video call connection request message from the mobile terminal and; and
if the called party is not a video call service subscriber, transmitting to the mobile terminal a message indicating that the called party is not a video call service subscriber.

13. A method for performing a video call connection in a mobile terminal having a video call function, the method comprising the steps of:
receiving a response message from a video call management server in response to a video call connection request message for a party;
determining whether the received message is a video call connection failure message; and
if the received response message is a video call connection failure message, detecting the cause of the video call connection failure from the received response message.

14. The method of claim 13, further comprising a step of displaying the detected failure cause.

15. The method of claim 13, further comprising, if the received response message is not a video call connection failure message, performing a video call connection with the party.

16. The method of claim 14, the step of displaying the detected failure cause is displaying a message indicating that the called party is not a video call service subscriber, if the video call connection fails because the called party is not a video call service subscriber or displaying a message indicating that the called party is temporarily unable to receive video call service if the video call connection fails because the called party is temporarily unable to receive video call service due to communication obstacles.

17. A mobile terminal having a video call function for performing a video call connection comprising:
means for receiving a response message from a video call management server in response to a video call connection request message for a party;
means for determining whether the received message is a video call connection failure message; and
means for detecting the cause of the video call connection failure from the received response message if the received response message is a video call connection failure message.

18. The mobile terminal of claim 17, further comprising means for displaying the detected failure cause.

19. The mobile terminal of claim 17, further comprising, means for performing a video call connection with the party if the received response message is not a video call connection failure message.

20. A computer-readable recording medium having recorded thereon a program for performing a video call connection in a mobile terminal having a video call function, comprising:
a first code segment, for receiving a response message from a video call management server in response to a video call connection request message for a party; and
a second code segment, determining whether the received message is a video call connection failure message; and
a third code segment, detecting the cause of the video call connection failure from the received response message if the received response message is a video call connection failure message.
